(19) United States
(12) Patent Application Publication
(10) Pub. No.: US 2025/0285592 A1
(43) Pub. Date: Sep. 11, 2025

(54) PIXEL, AND DISPLAY DEVICE AND ELECTRONIC DEVICE INCLUDING THE SAME

(71) Applicant: Samsung Display Co., LTD., Yongin-si (KR)

(72) Inventors: Jong Sik SHIM, Yongin-si (KR); Seon Kyoon MOK, Yongin-si (KR); Min Woo BYUN, Yongin-si (KR); Dong Hwan JEON, Yongin-si (KR); Sung Chan HWANG, Yongin-si (KR)

(73) Assignee: Samsung Display Co., LTD., Yongin-si (KR)

(21) Appl. No.: 18/961,854

(22) Filed: Nov. 27, 2024

(30) Foreign Application Priority Data
Mar. 8, 2024 (KR) 10-2024-0032949

(51) Int. Cl. G09G 3/3233; G09G 3/32; G09G 3/3266; G09G 3/3275

(52) U.S. Cl. CPC G09G 3/3233; G09G 3/32; G09G 3/3266; G09G 3/3275; G09G 2310/0267; G09G 2310/0275; G09G 2330/021

(57) ABSTRACT

A pixel includes a first transistor including a first electrode connected to a first power line, a first gate electrode connected to a first node, and a second electrode connected to a second node, a second transistor connected between a data line and the first node, and including a gate electrode connected to a first scan line, a light emitting element including a first electrode connected to the second electrode of the first transistor, and a second electrode connected to a second power line, and a first capacitor and a second capacitor connected in series between the first node and the first electrode of the light emitting element.

### CROSS-REFERENCE TO RELATED APPLICATION(S)

This application claims priority to and benefits of Korean patent application number 10-2024-0032949 under 35 U.S.C. 119, filed on Mar. 8, 2024, in the Korean Intellectual Property Office, the entire contents of which are incorporated herein by reference.

### BACKGROUND

### 1. Technical Field

Various embodiments of the disclosure relate to a pixel, and a display device and an electrode device including the pixel.

### 2. Description of Related Art

With the development of information technology, the importance of display devices as a medium connecting users and information has been emphasized. Owing to the importance of display devices, the use of various kinds of display devices, such as a liquid crystal display device and an organic light-emitting display device, has increased.

Display devices may display images using pixels. Each of the pixels may store a voltage of a data signal, and generate light at a certain luminance based on the amount of current flowing from first driving power to second driving power via a light emitting element. Here, in the case where the desired voltage of the data signal is not stored in each of the pixels due to a variation in voltage of the first driving power, an image of a desired luminance may not be displayed.

### SUMMARY

Various embodiments of the disclosure are directed to a pixel, and a display device and an electronic device including the pixel capable of displaying an image with a desired luminance regardless of variation in voltage of first driving power.

According to an embodiment of the disclosure, a pixel may include a first transistor including a first electrode connected to a first power line, a first gate electrode connected to a first node, and a second electrode connected to a second node, a second transistor connected between a data line and the first node, and including a gate electrode connected to a first scan line, a light emitting element including a first electrode connected to the second electrode of the first transistor, and a second electrode connected to a second power line, and a first capacitor and a second capacitor connected in series between the first node and the first electrode of the light emitting element.

In an embodiment, the first transistor may further include a second gate electrode, and the second gate electrode may be connected to the second node.

In an embodiment, the pixel may further include a third transistor connected between a third power line and the first node, and including a gate electrode connected to a second scan line, and a fourth transistor connected between the first electrode of the light emitting element and a fourth power line, and including a gate electrode connected to a third scan line.

In an embodiment, in case that the second transistor is turned on, the fourth transistor may be set to a turn-on state.

In an embodiment, in case that the second transistor is turned on, the fourth transistor may be set to a turn-off state.

In an embodiment, a turn-on period of the third transistor and a turn-on period of the fourth transistor may overlap during some periods, and a turn-on period of the second transistor and the turn-on period of the third transistor may not overlap.

In an embodiment, the pixel may further include a fifth transistor connected between the first power line and the first electrode of the first transistor, and including a gate electrode connected to a first emission control line, and a sixth transistor connected between the second node and the first electrode of the light emitting element, and including a gate electrode connected to the second emission control line.

In an embodiment, the sixth transistor may have a turn-on period overlapping a turn-on period of the third transistor during a first period, the fifth transistor may have a turn-on period overlapping the turn-on period of the third transistor during a second period, and the first period and the second period may not overlap.

In an embodiment, the fourth transistor may be set to a turn-on state during the first period and the second period.

According to an embodiment of the disclosure, a display device may include a pixel component including pixels connected to scan lines, emission control lines, and data lines, a scan driver that drives the scan lines, a data driver that drives the data lines, and an emission driver that drives the emission control lines. One of the pixels connected to an i-th horizontal line and a j-th data line (where i and j each may be a natural number) may include a first transistor including a first electrode connected to a first power line, a first gate electrode connected to a first node, and a second electrode and a second gate electrode connected to a second node, a second transistor that is connected between a data line and the first node, and turned on in case that a first enable scan signal is supplied to a first scan line of an i-th scan line, a light emitting element including a first electrode connected to the second electrode of the first transistor, and a second electrode connected to a second power line, and a first capacitor and a second capacitor connected in series between the first node and the first electrode of the light emitting element.

In an embodiment, the one of the pixels may further include a third transistor that is connected between a third power line and the first node, and turned on in case that a second enable scan signal is supplied to a second scan line of the i-th scan line, and a fourth transistor that is connected between the first electrode of the light emitting element and a fourth power line, and turned on in case that a third enable scan signal is supplied to a third scan line of the i-th scan line.

In an embodiment, the one of the pixels may further include a fifth transistor that is connected between the first power line and the first electrode of the first transistor, and turned off in case that a first disable emission control signal is supplied to a first emission control line of an i-th emission control line, and a sixth transistor that is connected between the second node and the first electrode of the light emitting element, and turned off in case that a second disable emission control signal is supplied to a second emission control line of the i-th emission control line.

In an embodiment, the one of the pixels may be driven with a first period, a second period, a third period, and a fourth period divided from each other, and the scan driver may supply the second enable scan signal and the third enable scan signal during the first period and the second period, and may supply the first enable scan signal during the third period.

In an embodiment, the scan driver may supply the third enable scan signal during the third period.

In an embodiment, the emission driver may supply the first disable emission control signal during the first period and the third period, and may supply the second disable emission control signal during the second period and the third period.

In an embodiment, the emission driver may supply a first enable emission control signal to the first emission control line during the fourth period to turn on the fifth transistor, and the emission driver may supply a second enable emission control signal to the second emission control line during the fourth period to turn on the sixth transistor.

In an embodiment, first driving power may be supplied to the first power line, second driving power having a voltage lower than the first driving power may be supplied to the second power line, a voltage of reference power may be supplied to the third power line, and a voltage of initialization power may be supplied to the fourth power line.

In an embodiment, each of the reference power and the initialization power may maintain a constant voltage.

According to an embodiment of the disclosure, an electronic device may include a display module that displays an image, a sensing module that senses an input corresponding to the image displayed on the display module, a processor and an auxiliary processor that controls the display module and the sensing module, and a display panel including the display module, and displaying the image. At least one pixel included in the display panel may include a first transistor including a first electrode connected to a first power line, a first gate electrode connected to a first node, and a second electrode and a second gate electrode connected to a second node, a second transistor connected between a data line and the first node, and including a gate electrode connected to a first scan line, a light emitting element including a first electrode connected to the second electrode of the first transistor, and a second electrode connected to a second power line, and a first capacitor and a second capacitor connected in series between the first node and the first electrode of the light emitting element.

In an embodiment, the at least one pixel may further include a third transistor connected between a third power line and the first node, and including a gate electrode connected to a second scan line, a fourth transistor connected between the first electrode of the light emitting element and a fourth power line, and including a gate electrode connected to a third scan line, a fifth transistor connected between the first power line and the first electrode of the first transistor, and including a gate electrode connected to a first emission control line, and a sixth transistor connected between the second node and the first electrode of the light emitting element, and including a gate electrode connected to the second emission control line.

The objects of the disclosure are not limited to the above-stated object, and those skilled in the art will clearly understand other not mentioned objects from the accompanying claims.

### BRIEF DESCRIPTION OF THE DRAWINGS

FIG. 1 is a schematic diagram illustrating a display device in accordance with an embodiment of the disclosure.

FIG. 2 is a schematic diagram illustrating an embodiment of a scan driver and an emission driver that are illustrated in FIG. 1.

FIG. 3 is a schematic diagram illustrating an equivalent circuit of a pixel in accordance with an embodiment of the disclosure.

FIG. 4 is a waveform illustrating an embodiment of a method of driving the pixel shown in FIG. 3.

FIGS. 5A to 5D are waveforms illustrating a process of operating the pixel corresponding to the pixel driving method.

FIG. 6 is a waveform illustrating an embodiment of a method of driving the pixel shown in FIG. 3.

FIG. 7 is a schematic diagram illustrating an electronic device in accordance with an embodiment of the disclosure.

### DETAILED DESCRIPTION OF THE EMBODIMENTS

Hereinafter, embodiments of the disclosure will be described in detail with reference to the attached drawings, such that those skilled in the art can readily implement the disclosure. The disclosure may be implemented in various forms, and is not limited to the embodiments to be described herein below.

In the drawings, portions which are not related to the disclosure will be omitted in order to explain the disclosure more clearly. Reference should be made to the drawings, in which similar reference numerals are used throughout the different drawings to designate similar components. Therefore, the aforementioned reference numerals may be used in other drawings.

Furthermore, the expression “being the same” may mean “being substantially the same”. In other words, the expression “being the same” may include a range that can be tolerated by those skilled in the art. The other expressions may also be expressions from which the term “substantially” has been omitted.

Some embodiments are described in the accompanying drawings in connection with functional blocks, units and/or modules. Those skilled in the art will understand that such blocks, units, and/or modules are physically implemented by logic circuits, discrete components, microprocessors, hard-wired circuits, memory elements, line connections, and other electronic circuits. This may be formed using semiconductor-based fabrication techniques or other fabrication techniques. For blocks, units, and/or modules implemented by a microprocessor or other similar hardware, they may be programmed and controlled using software to perform various functions discussed herein, and may be optionally driven by firmware and/or software. In addition, each block, unit, and/or module may be implemented by dedicated hardware, or be implemented by a combination of the dedicated hardware which performs some functions and a processor which performs different functions (e.g. one or more programmed microprocessors and related circuits). Furthermore, in some embodiments, blocks, units and/or modules may be physically separated into two or more individual blocks, units and/or modules which interact with each other without departing from the scope of the disclosure. In some embodiments, blocks, units and/or modules may be physically combined into more complex blocks, units and/or modules without departing from the scope of the disclosure.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Also, when an element is referred to as being “in contact” or “contacted” or the like to another element, the element may be in “electrical contact” or in “physical contact” with another element; or in “indirect contact” or in “direct contact” with another element.

It will be understood that, although the terms “first”, “second”, etc. may be used herein to describe various elements, these elements should not be limited by these terms. These terms are only used to distinguish one element from another element. For instance, a first element discussed below could be termed a second element without departing from the teachings of the disclosure.

In the specification and the claims, the phrase “at least one of” is intended to include the meaning of “at least one selected from the group of” for the purpose of its meaning and interpretation. For example, “at least one of A and B” may be understood to mean “A, B, or A and B.” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

However, the disclosure is not limited to the following embodiments and may be modified into various forms. Each embodiment to be described below may be implemented alone, or combined with at least another embodiment to make various combinations of embodiments.

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

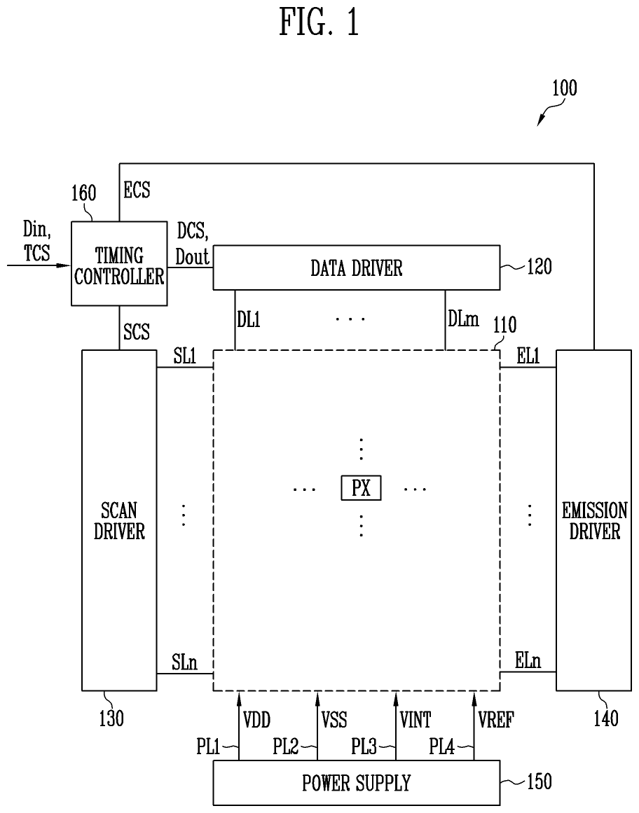

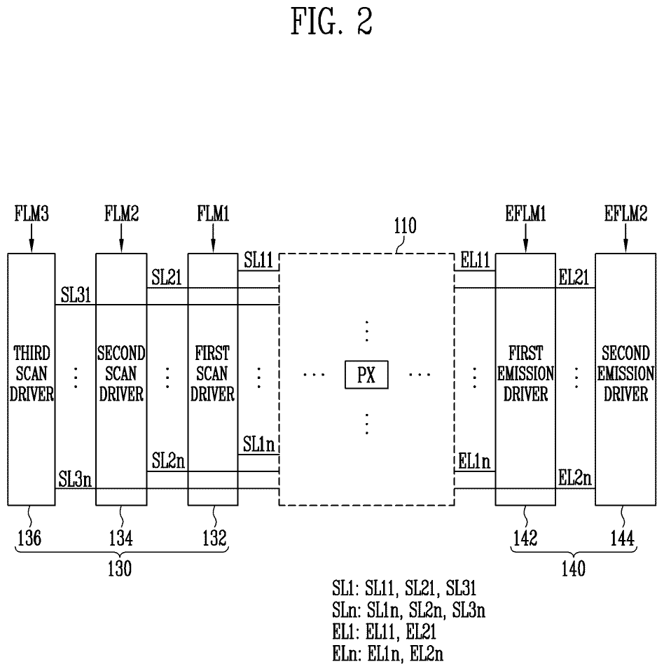

FIG. 1 is a schematic diagram illustrating a display device 100 in accordance with an embodiment of the disclosure. FIG. 2 is a schematic diagram illustrating an embodiment of a scan driver 130 and an emission driver 140 that are illustrated in FIG. 1.

Referring to FIG. 1, the display device 100 in accordance with an embodiment of the disclosure may include a pixel component 110 (or a display panel), a data driver 120, the scan driver 130, an emission driver 140, a power supply 150, and a timing controller 160.

The pixel component 110 may include pixels PX connected to scan lines SL1 to SLn, data lines DL1 to DLm, emission control lines EL1 to ELn, and power lines PL1, PL2, PL3, and PL4 (where n and m each may be a natural number of 2 or more).

Each of the scan lines SL1 to SLn may include three scan lines, as illustrated in FIG. 2. For example, the scan line SL1 may include a first scan line SL11, a second scan line SL21, and a third scan line SL31. For example, the scan line SLn may include a first scan line SL1n, a second scan line SL2n, and a third scan line SL3n.

The pixels PX may be arranged in a horizontal line basis (e.g., pixels PX connected to a same scan line may form a single horizontal line) in case that a first enable scan signal is supplied to the first scan lines SL11 to SL1n. Each of the pixels PX that are connected to the first enable scan signal may receive a data signal from a corresponding data line (any one of DL1 to DLm). The pixels PX that receive data signals may generate light of certain luminances corresponding to voltages of the data signals.

The scan driver 130 may receive a scan driving signal SCS from the timing controller 160. The scan driving signal SCS may include at least one scan start signal and clock signals for driving the scan driver 130. The scan driver 130 may generate a first enable scan signal, a second enable scan signal, and a third enable scan signal while shifting the scan start signal in response to the clock signals.

To achieve the foregoing purpose, as illustrated in FIG. 2, the scan driver 130 may include a first scan driver 132, a second scan driver 134, and a third scan driver 136. Depending on the design, at least some of the scan drivers 132, 134, and 136 may be integrated into a single driving circuit, module, or the like.

The first scan driver 132 may receive a first scan start signal FLM1 and generate first enable scan signals while shifting the first scan start signal FLM1 in response to clock signals. The first scan driver 132 may sequentially supply the first enable scan signals to the first scan lines SL11 to SL1n.

The second scan driver 134 may receive a second scan start signal FLM2 and generate second enable scan signals while shifting the second scan start signal FLM2 in response to clock signals. The second scan driver 134 may sequentially supply the second enable scan signals to the second scan lines SL21 to SL2n.

The third scan driver 136 may receive a third scan start signal FLM3 and generate third enable scan signals while shifting the third scan start signal FLM3 in response to clock signals. The third scan driver 136 may sequentially supply the third enable scan signals to the third scan lines SL31 to SL3n.

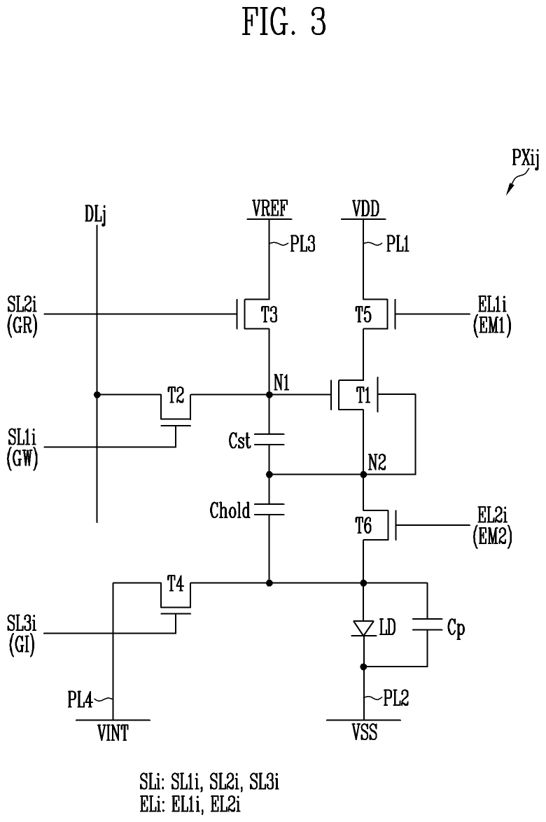

The first enable scan signals, the second enable scan signals, and the third enable scan signals may be set to a gate-on voltage to allow the transistors included in the pixels PX to be turned on. For example, as illustrated in FIG. 3, each of the first enable scan signal, the second enable scan signal, and the third enable scan signal to be supplied to an N-type transistor may be set to a high level voltage.

The data driver 120 may receive output data Dout and a data driving signal DCS from the timing controller 160. The data driving signal DCS may include a sampling signal and/or timing signals for driving the data driver 120. The data driver 120 may generate data signals, based on the data driving signal DCS and the output data Dout. For example, the data driver 120 may generate an analog data signal, based on a grayscale value of the output data Dout. The data driver 120 may supply data signals in units of one horizontal period.

The emission driver 140 may receive an emission driving signal ECS from the timing controller 160. The emission driving signal ECS may include an emission start signal and clock signals for driving the emission driver 140. The emission driver 140 may generate disable emission control signals while shifting the emission start signal in response to the clock signals.

Each of the emission control lines EL1 to ELn may include two emission control lines, as illustrated in FIG. 2. For example, the emission control line EL1 may include a first emission control line EL11 and a second emission control line EL21. For example, the emission control line ELn may include a first emission control line EL1n and a second emission control line EL2n. The emission driver 140 may generate a first disable emission control signal and a second disable emission control signal while shifting the emission start signal in response to the clock signals.

To achieve the foregoing purpose, as illustrated in FIG. 2, the emission driver 140 may include a first emission driver 142 and a second emission driver 144. Depending on the design, at least some of the emission drivers 142 and 144 may be integrated into a single driving circuit, module, or the like.

The first emission driver 142 may receive a first emission start signal EFLM1 and generate first disable emission control signals while shifting the first emission start signal EFLM1 in response to clock signals. The first emission driver 142 may sequentially supply the first disable emission control signals to the first emission control lines EL11 to EL1n.

The second emission driver 144 may receive a second emission start signal EFLM2 and generate second disable emission control signals while shifting the second emission start signal EFLM2 in response to clock signals. The second emission driver 144 may sequentially supply the second disable emission control signals to the second emission control lines EL21 to EL2n.

The first disable emission control signal and the second disable emission control signal may be set to a gate-off voltage to allow the transistors included in the pixels PX to be turned off. For example, as illustrated in FIG. 3, each of the first disable emission control signal and the second disable emission control signal to be supplied to an N-type transistor may be set to a low level voltage.

The timing controller 160 may receive input data Din and a timing control signal TCS from a host system through an interface. For example, the timing controller 160 may receive input data Din and a timing control signal TCS from at least one of a graphics processing unit (GPU), a central processing unit (CPU), and an application processor (AP) that are included in the host system. The timing control signal TCS may include various signals including a clock signal.

The timing controller 160 may generate a scan driving signal SCS, a data driving signal DCS, and an emission driving signal ECS, based on the timing control signal TCS. The scan driving signal SCS, the data driving signal DCS, and the emission driving signal ECS may be respectively supplied to the scan driver 130, the data driver 120, and the emission driver 140.

The timing controller 160 may rearrange the input data Din to match specifications of the display device 100. Furthermore, the timing controller 160 may correct the input data Din to generate output data Dout, and supply the output data Dout to the data driver 120. In an embodiment, the timing controller 160 may correct the input data Din in response to optical measurement results obtained during a fabrication process.

The power supply 150 may generate various types of power required for driving the display device 100. For example, the power supply 150 may generate first driving power VDD, second driving power VSS, initialization power VINT, and reference power VREF.

The first driving power VDD may be provided to supply driving current to the pixels PX. The second driving power VSS may be provided to receive the driving current from the pixels PX. During a period in which the pixels PX are set to an emission state, the first driving power VDD may be set to a voltage higher than a voltage of the second driving power VSS.

The initialization power VINT may be provided to initialize a first electrode (or an anode electrode) of a light emitting element included in each of the pixels. For example, the initialization power VINT may maintain a constant voltage. For example, the initialization power VINT may be a voltage that causes the light emitting element to be turned off when supplied to the anode electrode of the light emitting element. The reference power VREF may be supplied to a gate electrode of a driving transistor included in each of the pixels. For example, the reference power VREF may maintain a constant voltage. For example, the reference power VREF may be a specific voltage within a voltage range of a data signal. For example, the reference power VREF may be a voltage lower than the data signal.

Generated from the power supply 150, the first driving power VDD may be supplied to the first power line PL1, the second driving power VSS may be supplied to the second power line PL2, the initialization power VINT may be supplied to the third power line PL3, and the reference power VREF may be supplied to the fourth power line PL4. The first power line PL1, the second power line PL2, the third power line PL3, and the fourth power line PL4 may be connected in common to the pixels PX, but embodiments of the disclosure are not limited thereto.

In an embodiment, the first power line PL1 may be configured of multiple power lines. The power lines may be connected to different pixels PX. In an embodiment, the second power line PL2 may be configured of multiple power lines. The power lines may be connected to different pixels PX. In an embodiment, the third power line PL3 may be configured of multiple power lines. The power lines may be connected to different pixels PX. In an embodiment, the fourth power line PL4 may be configured of multiple power lines. The power lines may be connected to different pixels PX.

In an embodiment of the disclosure, the display device 100 may be a flat display device, a curved display device in which a portion of the pixel component 110 is curved, a flexible display device a portion of which can be folded or bent, or a stretchable display device a portion of which can be stretched.

In an embodiment of the disclosure, the display device 100 may be a device configured to display a video or a static image, and may be included in a portable electronic device such as a mobile phone, a smart phone, a tablet personal computer (a tablet PC), a smart watch, a watch phone, a mobile communication terminal, an electronic note, an electronic book, a potable multimedia player (PMP), a navigation device, and a ultra mobile PC (UMPC). In an embodiment of the disclosure, the display device 100 may be included in electronic devices such as a television, a laptop, a monitor, an advertisement board, and an Internet of Things (IoT) device.

FIG. 3 is a schematic diagram illustrating an equivalent circuit of a pixel PXij in accordance with an embodiment of the disclosure. FIG. 3 schematically illustrates a pixel PXij positioned on an i-th horizontal line and a j-th vertical line.

Referring to FIG. 3, the pixel PXij in accordance with an embodiment of the disclosure may be connected to corresponding signal lines SLi, DLj, and ELi. For example, the pixel PXij may be connected to an i-th scan line SLi, an i-th emission control line ELi, and a j-th data line DLj (where i may be a natural number of n or less, and j is a natural number of m or less). The i-th scan line SLi may include multiple scan lines SL1i, SL2i, and SL3i. The i-th emission control line ELi may include multiple emission control lines EL1i and EL2i. The pixel PXij may be further connected to the power lines PL1 to PL4.

The pixel PXij in accordance with an embodiment of the disclosure may include a light emitting element LD, and a pixel circuit configured to control the amount of current to be supplied to the light emitting element LD.

The light emitting element LD may be connected between the first power line PL1 and the second power line PL2. For example, a first electrode (e.g., an anode electrode) of the light emitting element LD may be connected to the first power line PL1 via a sixth transistor T6, a second node N2, a first transistor T1, and a fifth transistor T5. A second electrode (e.g., a cathode electrode) of the light emitting element LD may be connected to the second power line PL2. The light emitting element LD may generate light with a luminance corresponding to the amount of current supplied from the pixel circuit.

An organic light emitting diode may be selected as the light emitting element LD. Furthermore, an inorganic light emitting diode such as a micro light emitting diode (LED) or a quantum dot light emitting diode may be selected as the light emitting element LD. The light emitting element LD may be an element formed of a combination of organic material and inorganic material. Although FIG. 3 illustrates that the pixel PXij includes a single light emitting element LD, the disclosure is not limited thereto, and the pixel PXij in an embodiment may include multiple light emitting elements LD. The light emitting elements LD may be connected in series, parallel or series-parallel to each other.

The pixel circuit may include a first transistor T1, a second transistor T2, a third transistor T3, a fourth transistor T4, a fifth transistor T5, a sixth transistor T6, a first capacitor Cst, and a second capacitor Chold. In an embodiment, each of the first to sixth transistors T1 to T6 may be an oxide semiconductor transistor. For example, each of the first to sixth transistors T1 to T6 may include an active layer (or a semiconductor layer) including an oxide semiconductor layer. In an embodiment, each of the first to sixth transistors T1 to T6 may be an N-type oxide semiconductor transistor.

A first electrode of the first transistor T1 (or the driving transistor) may be connected to a second electrode of the fifth transistor T5. A second electrode of the first transistor T1 may be connected to the second node N2. A first gate electrode of the first transistor T1 may be connected to the first node N1. A second gate electrode (or a back gate electrode) of the first transistor T1 may be connected to the second node N2. The first transistor T1 may control, in response to the voltage of the first node N1, the amount of current to be supplied from the first driving power VDD to the second driving power VSS via the light emitting element LD.

The first transistor T1 may be formed of a double-gate transistor including the first gate electrode and the second gate electrode. In the case where the second gate electrode is connected to the second node N2, a gate-source voltage and driving current of the first transistor T1 may be stably maintained.

The second transistor T2 may be connected between the data line DLj and the first node N1. Agate electrode of the second transistor T2 may be connected to the first scan line SL1i. In the case where a first enable scan signal GW (or first high-level scan signal GW) is supplied to the first scan line SL1i, the second transistor T2 may be turned on to electrically connect the data line DLj to the first node N1.

The third transistor T3 may be connected between the third power line PL3 and the first node N1. Agate electrode of the third transistor T3 may be connected to the second scan line SL2i. In the case where a second enable scan signal GR (or second high-level scan signal GR) is supplied to the second scan line SL2i, the third transistor T3 may be turned on to electrically connect the third power line PL3 to the first node N1. In the case where the third power line PL3 and the first node N1 are electrically connected to each other, the voltage of the reference power VREF may be supplied to the first node N1.

The fourth transistor T4 may be connected between the first electrode of the light emitting element LD and the fourth power line PL4. A gate electrode of the fourth transistor T4 may be connected to the third scan line SL3i. In the case where a third enable scan signal GI (or third high-level scan signal GI) is supplied to the third scan line SL3i, the fourth transistor T4 may be turned on to electrically connect the fourth power line PL4 to the first electrode of the light emitting element LD.

In the case where the fourth power line PL4 and the first electrode of the light emitting element LD are electrically connected to each other, the voltage of the initialization power VINT may be supplied from the fourth power line PL4 to the first electrode of the light emitting element LD, and a parasitic capacitor Cp formed equivalently to the light emitting element LD may be discharged, so that the black expression performance may be enhanced.

The fifth transistor T5 may be connected between the first power line PL1 and the first electrode of the first transistor T1. Agate electrode of the fifth transistor T5 may be connected to the first emission control line EL1i. The fifth transistor T5 may be turned off in case that a first disable emission control signal EM1 (or first low-level emission control signal EM1) is supplied the gate electrode of fifth transistor T5, and may be turned on in case that a first enable emission control signal EM1 (or first high-level emission control signal EM1) is supplied the gate electrode of fifth transistor T5. In the case where the fifth transistor T5 is turned on, a current path along which driving current can flow in the pixel PXij may be formed.

The sixth transistor T6 may be connected between the second node N2 and the first electrode of the light emitting element LD. The second node N2 may be a node electrically connected with the second electrode of the first transistor T1 and a first electrode of the sixth transistor T6. A gate electrode of the sixth transistor T6 may be connected to the second emission control line EL2i. The sixth transistor T6 may be turned off in case that a second disable emission control signal EM2 (or second low-level emission control signal EM2) is supplied to the gate electrode of the sixth transistor T6, and may be turned on in case that a second enable emission control signal EM2 (or second high-level emission control signal EM2) is supplied to the gate electrode of the sixth transistor T6.

In the case where the sixth transistor T6 is turned on, the second node N2 and the first electrode of the light emitting element LD may be electrically connected to each other. In the case where the sixth transistor T6 is turned on, a current path along which driving current can be supplied to the light emitting element LD may be formed. In the case where the sixth transistor T6 is turned off, the second node N2 and the first electrode of the light emitting element LD may be electrically interrupted from each other, so that the current path along which the driving current can flow to the light emitting element LD may be interrupted.

The first capacitor Cst may be connected between the first node N1 and the second node N2. A voltage corresponding to a data signal may be stored in the first capacitor Cst.

The second capacitor Chold may be connected between the second node N2 and the first electrode of the light emitting element LD. The second capacitor Chold may stabilize the voltage of the second node N2.

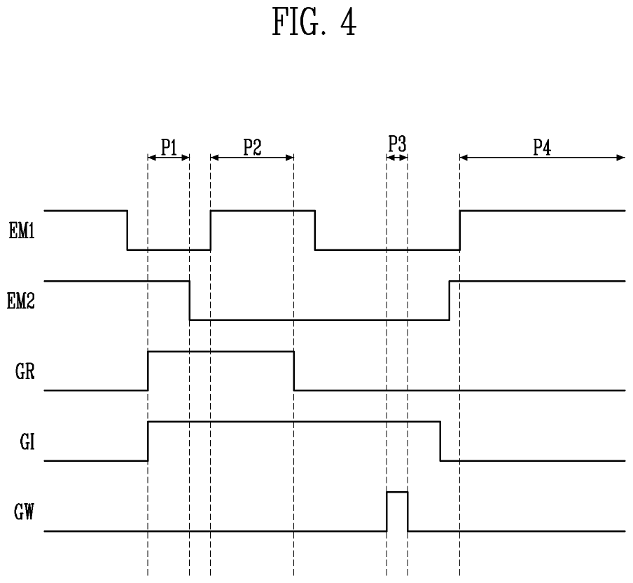

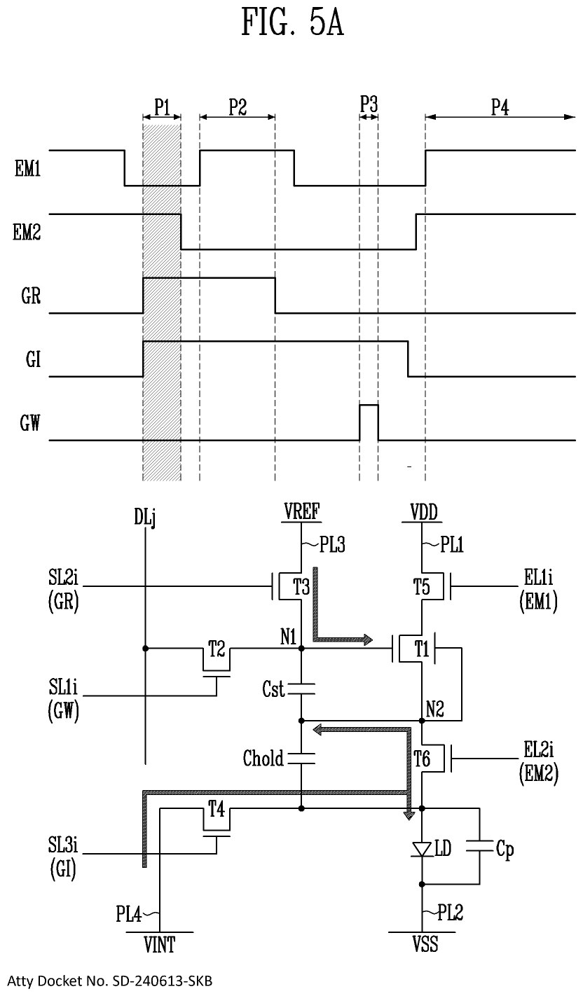

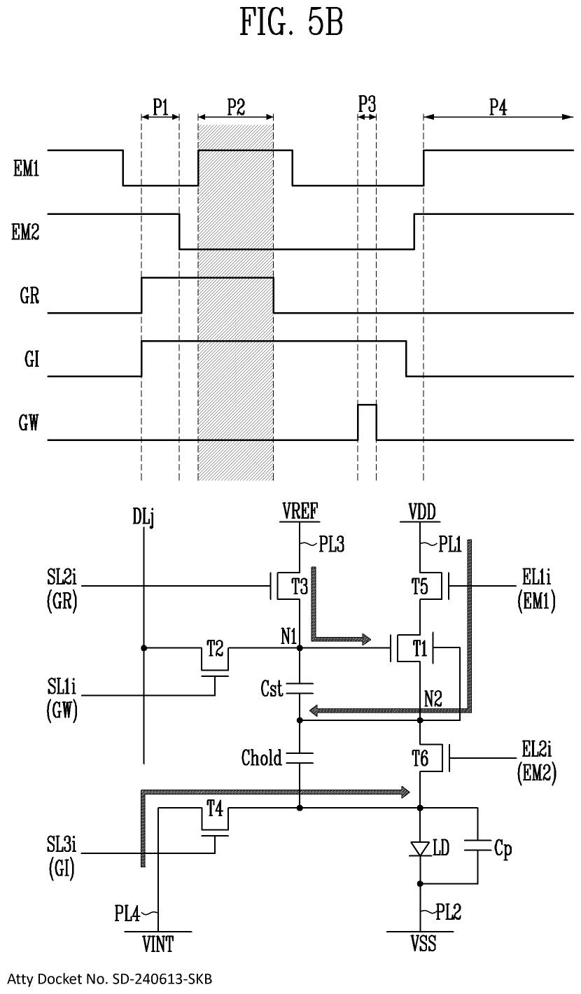

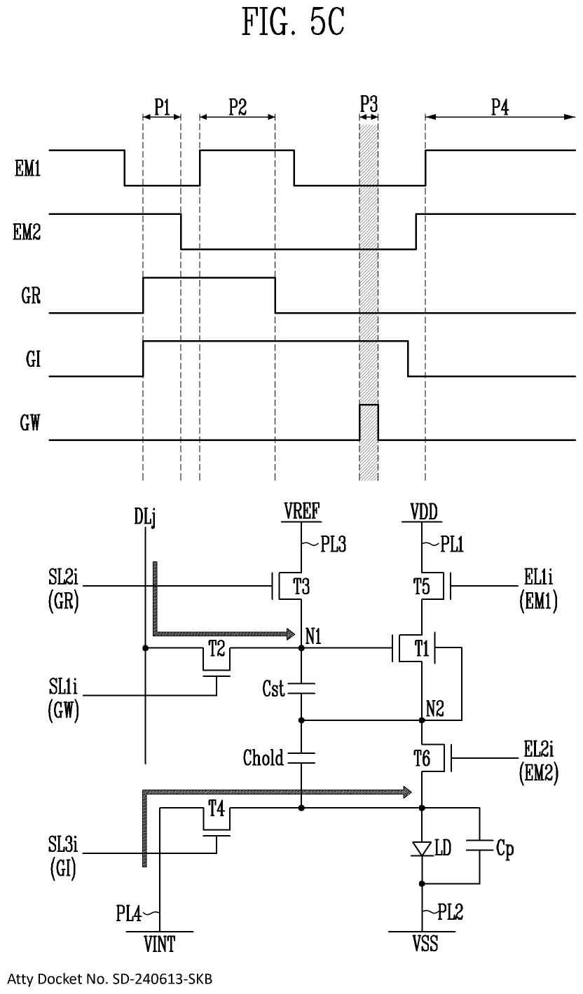

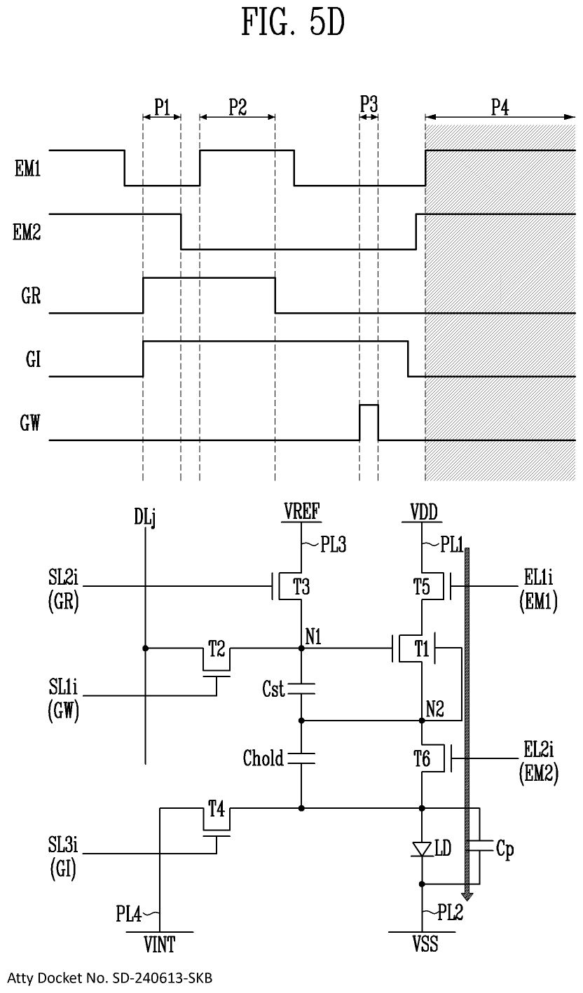

FIG. 4 is a waveform illustrating an embodiment of a method of driving the pixel PXij shown in FIG. 3. FIGS. 5A to 5D are waveforms illustrating a process of operating the pixel corresponding to the pixel driving method.

Referring to FIG. 4, the pixel PXij may be driven with a first period P1, a second period P2, a third period P3, and a fourth period P4 divided from each other.

The first period P1 may be a period for initializing the first capacitor Cst. The second period P2 may be a period for compensating for the threshold voltage of the first transistor T1. The third period P3 may be a period in which the voltage of a data signal is stored in the pixel PXij. The fourth period P4 may be a period in which the pixel PXij (or light emitting element LD) emits light.

Referring to FIG. 5A, during the first period P1, the second enable scan signal GR may be supplied to the second scan line SL2i, and the third enable scan signal GI may be supplied to the third scan line SL3i. Furthermore, during the first period P1, the first disable emission control signal EM1 may be supplied to the first emission control line EL1i.

If the first disable emission control signal EM1 is supplied to the first emission control line EL1i, the fifth transistor T5 may be turned off. If the fifth transistor T5 is turned off, the electrical connection between the first power line PL1 and the first transistor T1 may be interrupted, and accordingly, the light emitting element LD may be set to a non-emission state.

If the second enable scan signal GR is supplied to the second scan line SL2i, the third transistor T3 is turned on. If the third transistor T3 is turned on, the voltage of the reference power VREF may be supplied to the first node N1.

If the third enable scan signal GI is supplied to the third scan line SL3i, the fourth transistor T4 may be turned on. If the fourth transistor T4 is turned on, the voltage of the initialization power VINT may be supplied to the first electrode of the light emitting element LD and the second node N2. The storage capacitor Cst may be initialized with the voltage of the reference power VREF and the voltage of the initialization power VINT.

Referring to FIG. 5B, during the second period P2, the supply of the first disable emission control signal EM1 to the first emission control line EL1i may be interrupted, and the second disable emission control signal EM2 may be supplied to the second emission control line EL2i. During the second period P2, the second enable scan signal GR may be supplied to the second scan line SL2i, and the third enable scan signal GI may be supplied to the third scan line SL3i.

If the supply of the first disable emission control signal EM1 to the first emission control line EL1i is interrupted (or if the first enable emission control signal EM1 is supplied), the fifth transistor T5 may be turned on. If the fifth transistor T5 is turned on, the voltage of the first driving power VDD may be supplied to the first electrode of the first transistor T1.

If the second disable emission control signal EM2 is supplied to the second emission control line EL2i, the sixth transistor T6 may be turned off. If the sixth transistor T6 is turned off, the second node N2 and the first electrode of the light emitting element LD may be electrically interrupted from each other.

If the third enable scan signal GI is supplied to the third scan line SL3i, the fourth transistor T4 is turned on. If the fourth transistor T4 is turned on, the voltage of the initialization power VINT may be supplied to the first electrode of the light emitting element LD.

If the second enable scan signal GR is supplied to the second scan line SL2i, the third transistor T3 is turned on. If the third transistor T3 is turned on, the voltage of the reference power VREF may be supplied to the first node N1.

The voltage of the reference power VREF may be set to enable the first transistor T1 to be turned on so that the voltage of the second node N2 may increase in response to current supplied from the first driving power VDD to the second node N2 via the first transistor T1. During the second period P2, the voltage of the second node N2 may increase to a value obtained by subtracting an absolute threshold voltage of the first transistor T1 from the reference power VREF. In other words, during the second period P2, a voltage corresponding to the threshold voltage of the first transistor T1 may be stored in the first capacitor Cst.

The width of the second period P2 may be determined by a supply time of the first enable emission control signal EM1 and the second enable scan signal GR. In other words, in an embodiment of the disclosure, a threshold voltage compensation time (i.e., the second period P2) of the first transistor T1 may be controlled by controlling the supply time of the first enable emission control signal EM1 and the second enable scan signal GR.

Referring to FIG. 5C, during the third period P3, the first disable emission control signal EM1 may be supplied to the first emission control line EL1i, the second disable emission control signal EM2 may be supplied to the second emission control line EL2i, the first enable scan signal GW may be supplied to the first scan line SL1i, and the third enable scan signal GI may be supplied to the third scan line SL3i.

If the first disable emission control signal EM1 is supplied to the first emission control line EL1i, the fifth transistor T5 may be turned off. If the second disable emission control signal EM2 is supplied to the second emission control line EL2i, the sixth transistor T6 may be turned off. If the third enable scan signal GI is supplied to the third scan line SL3i, the fourth transistor T4 may be turned on so that the voltage of the initialization power VINT may be supplied to the first electrode of the light emitting element LD.

If the first enable scan signal GW is supplied to the first scan line SL1i, the second transistor T2 may be turned on. If the second transistor T2 is turned on, a data signal may be supplied from the data line DLj to the first node N1. During the third period P3, the voltage VN1 of the first node N1 and the voltage VN2 of the second node N2 may be represented by Equation 1.

$$Vn 1 = Vdata \qquad [ Equation 1 ]$$

$$VN 2 = VREF - Vth 1$$

In Equation 1, Vdata may be a voltage of the data signal, and Vth1 may be a threshold voltage of the first transistor T1.

In Equation 1, for convenience of explanation, the second node N2 has been described as maintaining a voltage of VREF−Vth1 during the third period P3, but the embodiments of the disclosure are not limited thereto.

For example, during the third period P3, the voltage VN1 of the first node N1 may be changed from the voltage of the reference power VREF to the voltage Vdata of the data signal, and the voltage VN2 of the second node N2 may be changed by coupling of the first capacitor Cst. However, because the second electrode of the second capacitor Chold (e.g., the electrode connected to the first electrode of the light emitting element LD) maintains the voltage of the initialization power VINT, variation in voltage of the second node N2 may be minimized.

For example, during the third period P3, the voltage VN2 of the second node N2 may vary in response to a ratio of the first capacitor Cst and the second capacitor Chold, whereby the variation in voltage VN2 of the second node N2 may be minimized.

Referring to FIG. 5D, during the fourth period P4, the first enable emission control signal EM1 may be supplied to the first emission control line EL1i, and the second enable emission control signal EM2 may be supplied to the second emission control line EL2i.

If the first enable emission control signal EM1 is supplied to the first emission control line EL1i, the fifth transistor T5 may be turned on so that the first power line PL1 and the first electrode of the first transistor T1 may be electrically connected to each other. If the second enable emission control signal EM2 is supplied to the second emission control line EL2i, the sixth transistor T6 may be turned on so that the second electrode of the first transistor T1 and the first electrode of the light emitting element LD may be electrically connected to each other.

The first transistor T1 may supply driving current corresponding to the voltage of the first node N1 from the first driving power VDD to the second driving power VSS via the light emitting element LD. Hence, during the fourth period P4, the light emitting element LD may generate light having a luminance corresponding to the driving current.

In a comparative example, in case that the second capacitor Chold is positioned between the first power line PL1 and the second node N2, the voltage of the second node N2 may be changed by the variation in voltage of the first driving power VDD supplied to the first power line PL1. Accordingly, an image of a desired luminance may not be displayed on the pixel PXij. Particularly, in the case where the voltage of the second node N2 is changed by the variation in voltage of the first driving power VDD during the third period P3 in which the voltage of the data signal is supplied to the pixel PXij, the voltage of the desired data signal may not be stored in the pixel PXij.

Compared to the comparative example, in an embodiment of the disclosure, the second capacitor Chold may be connected between the second node N2 and the first electrode of the light emitting element LD, so that the voltage of the second node N2 may be stably maintained regardless of variation in voltage of the first driving power VDD. For example, the first electrode of the light emitting element LD may be maintained at the voltage of the initialization power VINT during the third period P3 in which the voltage of the data signal is supplied to the pixel PXij. Accordingly, the voltage of the desired data signal may be stored in the pixel PXij.

For example, the pixel component 110 may be supplied with an inspection pattern in which the pixel component 110 is divided into multiple horizontal areas, with some areas set to an emission state and the remaining areas set to a non-emission state. In an embodiment, mura of the comparative example may be measured to be approximately 3.08%, and mura of the disclosure may be measured to be approximately 1.22%. For example, in the case of the disclosure, display quality may be further enhanced.

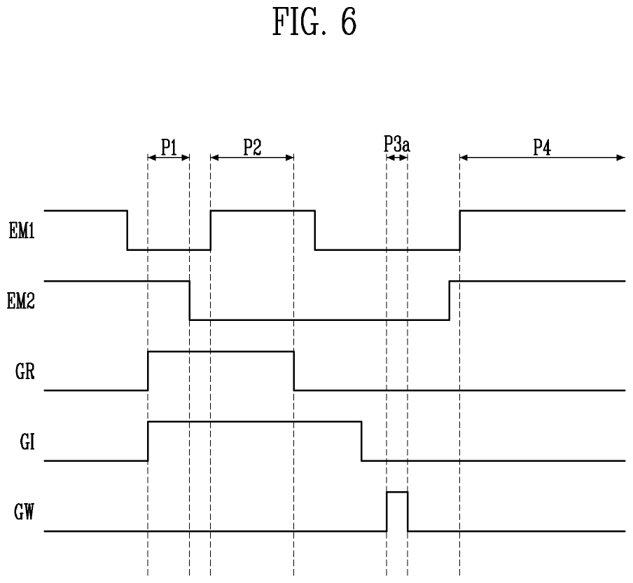

FIG. 6 is a waveform illustrating an embodiment of a method of driving the pixel shown in FIG. 3.

Referring to FIGS. 3 and 6, the pixel PXij may be driven with a first period P1, a second period P2, a third period P3a, and a fourth period P4 divided from each other. The first period P1, the second period P2, and the fourth period P4 may be the same as the periods P1, P2, and P4 of the driving method of FIG. 4, and repetitive explanation thereof will be omitted.

The third period P3a may be a period in which the voltage of the data signal is stored in the pixel PXij. During the third period P3a, the first disable emission control signal EM1 may be supplied to the first emission control line EL1i, the second disable emission control signal EM2 may be supplied to the second emission control line EL2i, and the first enable scan signal GW may be supplied to the first scan line SL1i.

If the first disable emission control signal EM1 is supplied to the first emission control line EL1i, the fifth transistor T5 may be turned off. If the second disable emission control signal EM2 is supplied to the second emission control line EL2i, the sixth transistor T6 may be turned off.

If the first enable scan signal GW is supplied to the first scan line SL1i, the second transistor T2 is turned on. If the second transistor T2 is turned on, a data signal may be supplied from the data line DLj to the first node N1. The voltage of the first node N1 and the voltage of the second node N2 during the third period P3a may be represented as Equation 1 described above.

During the third period P3a, the voltage of the first node N1 may be changed from the voltage of the reference power VREF to the voltage Vdata of the data signal, and the voltage of the second node N2 may be changed by coupling of the first capacitor Cst. The voltage of the second node N2 may vary in response to a ratio of the first capacitor Cst, the second capacitor Chold, and the parasitic capacitor Cp, whereby variation in voltage of the second node N2 may be minimized.

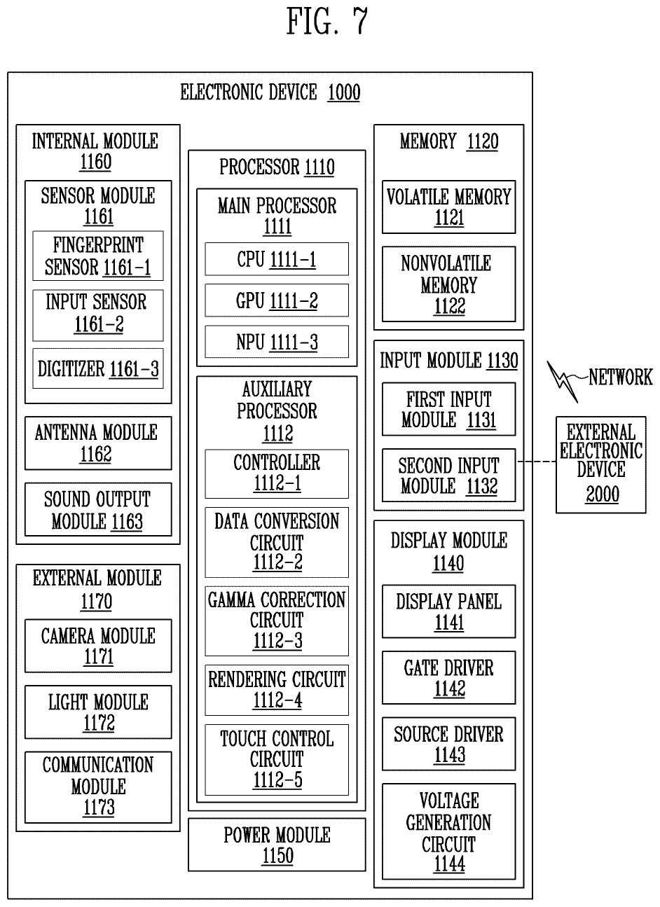

FIG. 7 is a schematic diagram illustrating an electronic device 1000 in accordance with an embodiment of the disclosure.

Referring to FIG. 7, the electronic device 1000 in accordance with an embodiment of the disclosure may output a variety of information through a display module 1140. If a processor 1110 executes an application stored in a memory 1120, the display module 1140 may provide application information to the user through a display panel 1141.

The processor 1110 may acquire an external input through an input module 1130 or a sensor module 1161, and execute an application corresponding to the external input. For example, in the case where the user selects a camera icon (or a camera application icon) displayed on the display panel 1141, the processor 1110 may acquire a user input through an input sensor 1161-2, and activate a camera module 1171. The processor 1110 may transmit image data corresponding to an image captured by the camera module 1171 to the display module 1140. The display module 1140 may display, on the display panel 1141, an image corresponding to the captured image.

In the case where personal information authentication is executed through the display module 1140, a fingerprint sensor 1161-1 may acquire input fingerprint information as input data. The processor 1110 may compare input data acquired through the fingerprint sensor 1161-1 with authentication data stored in the memory 1120, and may execute an application depending on a result of the comparison. The display module 1140 may display, on the display panel 1141, information executed according to the logic of the application. The fingerprint sensor 1161-1 may acquire fingerprint information in the overall area of the display module 1140 (or the display panel 1141).

In the case where a music streaming icon displayed on the display module 1140 is selected, the processor 1110 may acquire a user input through the input sensor 1161-2, and activate a music streaming application stored in the memory 1120. If a music playing command is input in the music streaming application, the processor 1110 may activate a sound output module 1163 and provide sound information corresponding to the music playing command to the user.

Hitherto, a brief description of the operation of the electronic device 1000 has been provided. Hereinafter, the configuration of the electronic device 1000 will be described in detail. Some of the components of the electronic device 1000 to be described below may be integrated into a single component, or one component may be separated into two or more components.

The electronic device 1000 may communicate with an external electronic device 2000 through a network (e.g., a short-range wireless communication network or a long-range wireless communication network). In an embodiment, the electronic device 1000 may include a processor 1110, a memory 1120, an input module 1130, a display module 1140, a power module 1150, an internal module 1160, and an external module 1170. In an embodiment, in the electronic device 1000, at least one of the foregoing components may be omitted, or one or more other components may be added. In an embodiment, some components (e.g., the sensor module 1161, an antenna module 1162, or the sound output module 1163) among the foregoing components may be integrated into another component (e.g., the display module 1140).

The processor 1110 may execute software to control at least one other component (e.g., a hardware or software component) of the electronic device 1000 connected to the processor 1110 and perform various data processing or computing operations. In an embodiment, as at least a portion of a data processing or computing operation, the processor 1110 may store a command or data received from another component (e.g., the input module 1130, the sensor module 1161, or a communication module 1173) in a volatile memory 1121, process the command or data stored in the volatile memory 1121, and store result data in a nonvolatile memory 1122.

The processor 1110 may include a main processor 1111 and an auxiliary processor 1112. The main processor 1111 may include a central processing unit (CPU) 1111-1. The main processor 1111 may further include one or more of a graphic processing unit (GPU) 1111-2, a communication processor (CP), and an image signal processor (ISP). The main processor 1111 may further include a neural processing unit (NPU) 1111-3. The NPU 1111-3 may be a processor specialized to process an artificial intelligence model. The artificial intelligence model may be generated by machine learning. The artificial intelligence model may include multiple artificial neural network layers. An artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-networks, or a combination of two or more among the foregoing networks, but the disclosure is not limited thereto. The artificial intelligence model may include not only a hardware structure but may also include an additional or substitutive software structure. At least two of the foregoing processing units and the processors may be implemented as a single integrated component (e.g., a single chip). In another embodiment, the processing units and the processors may be implemented as respective independent components (e.g., multiple chips).

The auxiliary processor 1112 may include a controller 1112-1. The controller 1112-1 may include an interface conversion circuit and a timing control circuit. For example, the controller 1112-1 may include the timing controller 160 shown in FIG. 1. The controller 1112-1 may receive an image signal from the main processor 1111, and may convert a data format of the image signal to a format corresponding to specifications of an interface with the display module 1140 and output image data. The controller 1112-1 may output various control signals to drive the display module 1140.

The auxiliary processor 1112 may further include a data conversion circuit 1112-2, a gamma correction circuit 1112-3, a rendering circuit 1112-4, a touch control circuit 1112-5, etc. The data conversion circuit 1112-2 may receive image data from the controller 1112-1, compensate for the image data to display an image at a desired luminance based on characteristics of the electronic device 1000 or settings of the user, or may convert the image data to reduce power consumption or compensate for afterimages.

The gamma correction circuit 1112-3 may convert image data, a gamma reference voltage, or the like so that an image to be displayed on the electronic device 1000 can have desired gamma characteristics. The rendering circuit 1112-4 may receive image data from the controller 1112-1, and render the image data taking into account pixel arrangement or the like on the display panel 1141 applied to the electronic device 1000.

The touch control circuit 1112-5 may supply a touch signal to the input sensor 1161-2, and receive a sensing signal from the input sensor 1161-2 in response to the touch signal.

At least one of the data conversion circuit 1112-2, the gamma correction circuit 1112-3, the rendering circuit 1112-4, and the touch control circuit 1112-5 may be integrated into another component (e.g., the main processor 1111 or the controller 1112-1). At least one of the data conversion circuit 1112-2, the gamma correction circuit 1112-3, and the rendering circuit 1112-4 may be integrated into a source driver 1143 to be described below.

The memory 1120 may store a variety of data to be used in at least one component (e.g., the processor 1110 or the sensor module 1161) of the electronic device 1000, and input data or output data for a command pertaining to the variety of data. Furthermore, the memory 1120 may store a variety of setting data corresponding to settings of the user. The memory 1120 may include at least one or more of the volatile memory 1121 and the nonvolatile memory 1122.

The input module 1130 may receive a command or data to be used in a component (e.g., the processor 1110, the sensor module 1161, or the sound output module 1163) of the electronic device 1000 from an external device (e.g., the user or an external electronic device 2000) provided outside the electronic device 1000.

The input module 1130 may include a first input module 1131 configured to receive a command or data from the user, and a second input module 1132 configured to receive a command or data from the external electronic device 2000. The first input module 1131 may include a microphone, a mouse, a keyboard, a key (e.g., a button), or a pen (e.g., a passive pen or an active pen). The second input module 1132 may support a designated protocol, which can be connected to the external electronic device 2000 in a wired or wireless manner. In an embodiment, the second input module 1132 may include a high definition multimedia interface (HDMI), a universal serial bus (USB) interface, an SD card interface, or an audio interface. The second input module 1132 may include a connector, e.g., an HDMI connector, a USB connector, an SD card connector, or an audio connector (e.g., a headphone connector), for physical connection with the external electronic device 2000.

The display module 1140 may provide visual information to the user. The display module 1140 may include a display panel 1141, a gate driver 1142, a source driver 1143, and a voltage generation circuit 1144. The display module 1140 may further include a window, a chassis, and a bracket to protect the display panel 1141. The display module 1140 may include at least some components of the display device 100 illustrated in FIG. 1.

The display panel 1141 (or a display) may include a liquid crystal display panel, an organic light emitting display panel, or an inorganic light emitting display panel. The type of display panel 1141 is not limited to a particular type. The display panel 1141 may be a rigid type panel, or a flexible type panel, which is rollable or foldable. The display module 1140 may further include a support, a bracket, or a heat dissipater, which supports the display panel 1141. The display panel 1141 may include the pixel component 110 illustrated in FIG. 1. In other words, the display panel 1141 may include the pixels PX illustrated in FIG. 1. Each of the pixels PX may include the pixel circuit and the light emitting element LD illustrated in FIG. 3.

The gate driver 1142 may be mounted on the display panel 1141 as a driving chip. The gate driver 1142 may be integrated on the display panel 1141. For example, the gate driver 1142 may include an amorphous silicon TFT gate (ASG) driver circuit, a low temperature polycrystalline silicon (LTPS) TFT gate driver circuit, or an oxide semiconductor TFT gate (OSG) driver circuit, which is internalized in the display panel 1141. The gate driver 1142 may receive a control signal from the controller 1112-1, and output scan signals to the display panel 1141 in response to the control signal. The gate driver 1142 may include the scan driver 130 illustrated in FIG. 1.

The display module 1140 may further include an emission driver (not illustrated in FIG. 7). The emission driver may output an emission control signal to the display panel 1141 in response to a control signal received from the controller 1112-1. The emission driver may be formed separately from the gate driver 1142, or may be integrated into the gate driver 1142. The emission driver may include the emission driver 140 illustrated in FIG. 1.

The source driver 1143 may receive a control signal from the controller 1112-1, convert image data to an analog voltage (e.g., a data signal) in response to the control signal, and output data signals to the display panel 1141. The source driver 1143 may include the data driver 120 illustrated in FIG. 1.

The source driver 1143 may be integrated into another component (e.g., the controller 1112-1). The functions of the interface conversion circuit and the timing control circuit of the controller 1112-1 may be integrated into the source driver 1143. The voltage generation circuit 1144 may output various voltages needed to drive the display panel 1141. For example, the voltage generation circuit 1144 may include the power supply 150 shown in FIG. 1.

In an embodiment, the source driver 1143 may convert data that is included in image data received from the processor 1110 and corresponds to red (R), green (G), and blue (B) to a red data signal (or a data voltage), a green data signal, and a blue data signal, and provide the data signals to multiple pixel columns included in the display panel 1141 during a single horizontal period.

The power module 1150 may supply power to the components of the electronic device 1000. The power module 1150 may include a battery to store power voltage. The battery may include a primary cell, which cannot be recharged, and a secondary cell or a fuel cell, which are rechargeable. The power module 1150 may include a power management integrated circuit (PMIC). The PMIC may supply optimized power to each of the foregoing modules and modules to be described below. The power module 1150 may include a wireless power transceiver that is electrically connected with the battery. The wireless power transceiver may include multiple coiled antenna radiators. In an embodiment, the power module 1150 and at least some components of the voltage generation circuit 1144 may be integrated into a single component. For example, the voltage generation circuit 1144 may be included in the power module 1150.

The electronic device 1000 may further include an internal module 1160 and an external module 1170. The internal module 1160 may include a sensor module 1161, an antenna module 1162, and a sound output module 1163. The external module 1170 may include a camera module 1171, a light module 1172, and a communication module 1173.

The sensor module 1161 may sense an input from a body of the user or an input from a pen of the first input module 1131, and generate an electric signal or a data value corresponding to the input. The sensor module 1161 may include at least one or more of a fingerprint sensor 1161-1, an input sensor 1161-2, and a digitizer 1161-3.

The fingerprint sensor 1161-1 may generate a data value corresponding to the fingerprint of the user.

The input sensor 1161-2 may generate a data value corresponding to coordinate information of the input from the body of the user or the input from the pen. The input sensor 1161-2 may generate a data value corresponding to the amount of change in capacitance by the input. The input sensor 1161-2 may sense an input from a passive pen, or transmit or receive data to or from an active pen.

The input sensor 1161-2 may measure a biometric signal pertaining to biometric information such as a blood pressure, body fluid, or body fat. For example, in the case where the user brings a part of his/her body into contact with the sensor layer or the sensing panel and remains stationary for a certain time, the input sensor 1161-2 may sense a biometric signal, based on a change in electric field by the part of his/her body, and output information desired by the user to the display module 1140.

The digitizer 1161-3 may generate a data value corresponding to coordinate information of an input from a pen. The digitizer 1161-3 may generate data values corresponding to electromagnetic variations caused by the input. The digitizer 1161-3 may sense an input from a passive pen, or transmit or receive data to or from an active pen.

At least one of the fingerprint sensor 1161-1, the input sensor 1161-2, and the digitizer 1161-3 may be implemented as a sensor layer formed on the display panel 1141 through a successive process. At least one among the fingerprint sensor 1161-1, the input sensor 1161-2, and the digitizer 1161-3 may be disposed over the display panel 1141. Any one among the fingerprint sensor 1161-1, the input sensor 1161-2, and the digitizer 1161-3, for example, the digitizer 1161-3, may be disposed under the display panel 1141.

At least two or more of the fingerprint sensor 1161-1, the input sensor 1161-2, and the digitizer 1161-3 may be formed to be integrated into a single sensing panel through a same process. In the case where at least two or more of the fingerprint sensor 1161-1, the input sensor 1161-2, and the digitizer 1161-3 are integrated into a single sensing panel, the sensing panel may be disposed between the display panel 1141 and a window disposed over the display panel 1141. In an embodiment, the sensing panel may be disposed on the window, and the position of the sensing panel is not particularly limited.

At least one of the fingerprint sensor 1161-1, the input sensor 1161-2, and the digitizer 1161-3 may be embedded in the display panel 1141. In other words, during a process of forming components (e.g., a light emitting element, a transistor, and the like) included in the display panel 1141, at least one of the fingerprint sensor 1161-1, the input sensor 1161-2, and the digitizer 1161-3 may be formed simultaneously with the components.

The sensor module 1161 may generate an electrical signal or data value corresponding to internal conditions or external conditions of the electronic device 1000. Although not illustrated, the sensor module 1161 may further include, for example, a gesture sensor, a gyroscope sensor, an atmospheric sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 1162 may include one or more antennas to transmit or receive a signal or power to or from an external device. In an embodiment, the communication module 1173 may transmit a signal to an external electronic device or receive a signal from the external electronic device through an antenna suitable for a communication scheme. An antenna pattern of the antenna module 1162 may be integrated to a component of the display module 1140 (e.g., the display panel 1141 of the display module 1140) or the input sensor 1161-2.

The sound output module 1163 may be a device for outputting a sound signal to a device provided outside the electronic device 1000, and, for example, may include a speaker, which is used for typical purposes such as reproducing multimedia or record data, and a receiver, which is used for phone reception. In an embodiment, the receiver may be integrally or separately formed with a speaker. A sound output pattern of the sound output module 1163 may be integrated into the display module 1140.

The camera module 1171 may capture a static image or a video. In an embodiment, the camera module 1171 may include one or more lenses, an image sensor, or an image signal processor. The camera module 1171 may further include an infrared camera capable of sensing the presence of the user, the position of the user, a line of sight of the user, etc.

The light module 1172 may provide light. The light module 1172 may include a light emitting diode or a xenon lamp. The light module 1172 may be operated interlocking with the camera module 1171 or operated independently therefrom.

The communication module 1173 may form a wired or wireless communication channel between the electronic device 1000 and the external electronic device 2000, and support execution of communication through the formed communication channel. The communication module 1173 may include at least one of a wireless communication module such as a cellular communication module, a short-range wireless communication module, a global navigation satellite system (GNSS) communication module, a wired communication module such as a local area network (LAN) communication module, and a power line communication module. The communication module 1173 may communicate with the external electronic device 2000 through a short-range communication network such as Bluetooth, WiFi Direct or infrared data association (IrDA), or a long-range communication network such as a cellular network, an internet, or a computer network (e.g., LAN or WAN). The various types of communication modules 1173 described above may be implemented as a single chip or may be implemented as respective separate chips.

The input module 1130, the sensor module 1161, the camera module 1171, and the like, interlocking with the processor 1110, may be used to control the operation of the display module 1140.

The processor 1110 may output a command or data to the display module 1140, the sound output module 1163, the camera module 1171, or the light module 1172, based on input data received from the input module 1130. For example, the processor 1110 may generate image data in response to input data applied through a mouse, an active pen, or the like and output the image data to the display module 1140, or may generate command data in response to input data and output the command data to the camera module 1171 or the light module 1172. In the case where input data is not received from the input module 1130, the processor 1110 may convert the operation mode of the electronic device 1000 to a low-power mode or a sleep mode, thus reducing the power consumption of the electronic device 1000.

The processor 1110 may output a command or data to the display module 1140, the sound output module 1163, the camera module 1171, or the light module 1172, based on sensing data received from the sensor module 1161. For example, the processor 1110 may compare authentication data applied from the fingerprint sensor 1161-1 with the authentication data stored in the memory 1120, and may execute an application depending on a result of the comparison. The processor 1110 may execute a command based on sensing data sensed by the input sensor 1161-2 or the digitizer 1161-3, or output corresponding image data to the display module 1140. In the case where the sensor module 1161 includes a temperature sensor, the processor 1110 may receive temperature data for a measured temperature from the sensor module 1161, and further execute a luminance correction operation for the image data based on the temperature data.

The processor 1110 may receive measurement data for the presence of the user, the position of the user, a line of sight of the user, or the like from the camera module 1171. The processor 1110 may further execute a luminance correction operation for the image data based on the measurement data. For example, the processor 1110 that has determined whether the user is present through an input from the camera module 1171 may output, to the display module 1140, image data the luminance of which is corrected by the data conversion circuit 1112-2 or the gamma correction circuit 1112-3.

Some components among the foregoing components may be connected to each other by a communication scheme, e.g., a bus, general purpose input/output (GPIO), a serial peripheral interface (SPI), a mobile industry processor interface (MIPI), or an ultra path interconnect (UPI) link, which can be used between peripheral devices, and may thus exchange a signal (e.g., a command or data) therebetween. The processor 1110 may communicate with the display module 1140 through an interface. For example, one of the foregoing communication schemes may be used, and the interface is not limited to the foregoing communication schemes.

In a pixel, and a display device and an electronic device including the pixel in accordance with embodiments of the disclosure, the voltage of a desired data signal may be stored in the pixel regardless of variation in voltage of first driving power.

Furthermore, in the pixel, and the display device and the electronic device including the pixel in accordance with embodiments of the disclosure, an image with a desired luminance may be displayed regardless of variation in voltage of the first driving power.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A pixel comprising:
a first transistor including a first electrode connected to a first power line, a first gate electrode connected to a first node, and a second electrode connected to a second node;
a second transistor connected between a data line and the first node, and including a gate electrode connected to a first scan line;
a light emitting element including a first electrode connected to the second electrode of the first transistor, and a second electrode connected to a second power line; and
a first capacitor and a second capacitor connected in series between the first node and the first electrode of the light emitting element.

2. The pixel according to claim 1, wherein
the first transistor further includes a second gate electrode, and
the second gate electrode is connected to the second node.

3. The pixel according to claim 1, further comprising:
a third transistor connected between a third power line and the first node, and including a gate electrode connected to a second scan line; and
a fourth transistor connected between the first electrode of the light emitting element and a fourth power line, and including a gate electrode connected to a third scan line.

4. The pixel according to claim 3, wherein in case that the second transistor is turned on, the fourth transistor is set to a turn-on state.

5. The pixel according to claim 3, wherein in case that the second transistor is turned on, the fourth transistor is set to a turn-off state.

6. The pixel according to claim 3, wherein
a turn-on period of the third transistor and a turn-on period of the fourth transistor overlap during some periods, and
a turn-on period of the second transistor and the turn-on period of the third transistor do not overlap.

7. The pixel according to claim 3, further comprising:
a fifth transistor connected between the first power line and the first electrode of the first transistor, and including a gate electrode connected to a first emission control line; and
a sixth transistor connected between the second node and the first electrode of the light emitting element, and including a gate electrode connected to the second emission control line.

8. The pixel according to claim 7, wherein
the sixth transistor has a turn-on period overlapping a turn-on period of the third transistor during a first period,
the fifth transistor has a turn-on period overlapping the turn-on period of the third transistor during a second period, and
the first period and the second period do not overlap.

9. The pixel according to claim 8, wherein the fourth transistor is set to a turn-on state during the first period and the second period.

10. A display device, comprising:
a pixel component including pixels connected to scan lines, emission control lines, and data lines;
a scan driver that drives the scan lines;
a data driver that drives the data lines; and
an emission driver that drives the emission control lines,
wherein one of the pixels connected to an i-th horizontal line and a j-th data line (where i and j each are a natural number) comprises:
a first transistor including a first electrode connected to a first power line, a first gate electrode connected to a first node, and a second electrode and a second gate electrode connected to a second node;
a second transistor that is connected between a data line and the first node, and turned on in case that a first enable scan signal is supplied to a first scan line of an i-th scan line;
a light emitting element including a first electrode connected to the second electrode of the first transistor, and a second electrode connected to a second power line; and
a first capacitor and a second capacitor connected in series between the first node and the first electrode of the light emitting element.

11. The display device according to claim 10, wherein the one of the pixels further comprises:
a third transistor that is connected between a third power line and the first node, and turned on in case that a second enable scan signal is supplied to a second scan line of the i-th scan line; and
a fourth transistor that is connected between the first electrode of the light emitting element and a fourth power line, and turned on in case that a third enable scan signal is supplied to a third scan line of the i-th scan line.

12. The display device according to claim 11, wherein the one of the pixels further comprises:
a fifth transistor that is connected between the first power line and the first electrode of the first transistor, and turned off in case that a first disable emission control signal is supplied to a first emission control line of an i-th emission control line; and
a sixth transistor that is connected between the second node and the first electrode of the light emitting element, and turned off in case that a second disable emission control signal is supplied to a second emission control line of the i-th emission control line.

13. The display device according to claim 12, wherein
the one of the pixels is driven with a first period, a second period, a third period, and a fourth period divided from each other, and
the scan driver supplies the second enable scan signal and the third enable scan signal during the first period and the second period, and supplies the first enable scan signal during the third period.

14. The display device according to claim 13, wherein the scan driver supplies the third enable scan signal during the third period.

15. The display device according to claim 13, wherein the emission driver supplies the first disable emission control signal during the first period and the third period, and supplies the second disable emission control signal during the second period and the third period.

16. The display device according to claim 15, wherein
the emission driver supplies a first enable emission control signal to the first emission control line during the fourth period to turn on the fifth transistor, and
the emission driver supplies a second enable emission control signal to the second emission control line during the fourth period to turn on the sixth transistor.

17. The display device according to claim 11, wherein
first driving power is supplied to the first power line,
second driving power having a voltage lower than the first driving power is supplied to the second power line,
a voltage of reference power is supplied to the third power line, and
a voltage of initialization power is supplied to the fourth power line.

18. The display device according to claim 17, wherein each of the reference power and the initialization power maintains a constant voltage.

19. An electronic device comprising:
a display module that displays an image;
a sensing module that senses an input corresponding to the image displayed on the display module;
a processor and an auxiliary processor that controls the display module and the sensing module; and
a display panel including the display module, and displaying the image,
wherein at least one pixel included in the display panel comprises:
a first transistor including a first electrode connected to a first power line, a first gate electrode connected to a first node, and a second electrode and a second gate electrode connected to a second node;
a second transistor connected between a data line and the first node, and including a gate electrode connected to a first scan line;
a light emitting element including a first electrode connected to the second electrode of the first transistor, and a second electrode connected to a second power line; and
a first capacitor and a second capacitor connected in series between the first node and the first electrode of the light emitting element.

20. The electronic device according to claim 19, wherein the at least one pixel further comprises:
a third transistor connected between a third power line and the first node, and including a gate electrode connected to a second scan line;
a fourth transistor connected between the first electrode of the light emitting element and a fourth power line, and including a gate electrode connected to a third scan line;
a fifth transistor connected between the first power line and the first electrode of the first transistor, and including a gate electrode connected to a first emission control line; and
a sixth transistor connected between the second node and the first electrode of the light emitting element, and including a gate electrode connected to the second emission control line.
